(19) United States
(12) Patent Application Publication
(10) Pub. No.: US 2026/0103340 A1
(43) Pub. Date: Apr. 16, 2026

(54) DRIVE ASSEMBLY FOR REFUSE VEHICLE LIFT SYSTEM

(71) Applicant: Oshkosh Corporation, Oshkosh, WI (US)

(72) Inventors: Brent Radlinger, Oshkosh, WI (US); Ryan Ullius, Oshkosh, WI (US); Jeremy Kiekhaefer, Oshkosh, WI (US); Erik S. Ellifson, Oshkosh, WI (US); Derek Wente, Oshkosh, WI (US); Martin Schimke, Oshkosh, WI (US); Bennett Unfried, Oshkosh, WI (US); Caleb Binder, Oshkosh, WI (US); Vince Schad, Oshkosh, WI (US)

(73) Assignee: Oshkosh Corporation, Oshkosh, WI (US)

(21) Appl. No.: 19/368,824

(22) Filed: Oct. 24, 2025

Related U.S. Application Data
(63) Continuation-in-part of application No. 18/399,544, filed on Dec. 28, 2023.
(60) Provisional application No. 63/435,928, filed on Dec. 29, 2022.
(60) Provisional application No. 63/712,091, filed on Oct. 25, 2024.
(60) Provisional application No. 63/712,115, filed on Oct. 25, 2024.
(60) Provisional application No. 63/712,106, filed on Oct. 25, 2024.
(60) Provisional application No. 63/712,098, filed on Oct. 25, 2024.

(51) Int. Cl. B65F 3/08; B65F 3/02

(52) U.S. Cl. CPC B65F 3/08; B65F 2003/023; B65F 2003/025; B65F 2003/0269

(57) ABSTRACT

A lift assembly for a refuse vehicle includes a track coupled to a chassis of the refuse vehicle. The lift assembly further includes a grabber assembly, a drive, and a drive mount. The grabber assembly is movably coupled to the track. The drive is configured to drive the grabber assembly to move along the track. The drive mount couples the drive to the track at a fixed position along the track such that the grabber assembly moves relative to the drive.

### CROSS-REFERENCE TO RELATED APPLICATIONS

The present application is a continuation-in-part of U.S. patent application Ser. No. 18/399,544, filed Dec. 28, 2023, which claims the benefit of and priority to U.S. Provisional Ser. No. 63/435,928 , filed Dec. 29, 2022. The present application also claims the benefit of and priority to U.S. Provisional Ser. No. 63/712,115, filed Oct. 25, 2024, U.S. Provisional Ser. No. 63/712,098 , filed Oct. 25, 2024, U.S. Provisional Application No. 63/712,106, filed Oct. 25, 2024, and U.S. Provisional Application No. 63/712,091, filed Oct. 25, 2024. The entire contents of each of these applications is hereby incorporated by reference herein.

### BACKGROUND

The present application generally relates to the field of refuse vehicles and, more specifically, to lift apparatuses for refuse vehicles.

### SUMMARY

At least one exemplary embodiment of the present disclosure relates to a refuse vehicle. The refuse vehicle includes a chassis and a lift assembly. The lift assembly is coupled to the chassis. The lift assembly includes a track, a grabber assembly, a drive, and a drive mount. The grabber assembly is movably coupled to the track. The drive is configured to drive the grabber assembly to move along the track. The drive mount couples the drive to the track at a fixed position along the track such that the grabber assembly moves relative to the drive.

At least one exemplary embodiment of the present disclosure relates to a lift system for a refuse vehicle, the lift system including: a lift assembly including: a lift arm configured to be coupled to the refuse vehicle; and a grabber assembly movably coupled to the lift arm; and a drive assembly coupled to the lift assembly, the drive assembly including: a drive; a tensile member coupled to the grabber assembly and extending substantially parallel to the lift arm; a gearbox engaging the drive with the tensile member; and a drive mount coupling at least one of the drive or the gearbox to the lift arm at a fixed position along the lift arm such that the grabber assembly moves relative to the at least one of the drive or the gearbox during operation.

At least one exemplary embodiment of the present disclosure relates to a drive system for a lift assembly, the drive system including: a drive; a tensile member configured to couple to a grabber assembly of the lift assembly; a gearbox engaging the drive with the tensile member; and a drive mount configured to couple at least one of the drive or the gearbox to a lift arm of the lift assembly at a fixed position along the lift arm such that the grabber assembly moves relative to the at least one of the drive or the gearbox during operation.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a refuse vehicle inclusive of a lift assembly, according to an exemplary embodiment;

FIG. 2 is another perspective view of the refuse vehicle of FIG. 1, according to an exemplary embodiment;

FIG. 3 is a front perspective view of the lift assembly of the refuse vehicle of FIG. 1, according to an exemplary embodiment;

FIG. 4 is a right side perspective view of a chain drive assembly that may be used with the lift assembly of FIG. 3, according to an exemplary embodiment;

FIG. 5 is a left side perspective view of the chain drive assembly of FIG. 4;

FIG. 6 is a rear perspective view of a drive assembly that may be used in the chain drive assembly of FIG. 4;

FIG. 7 is a side view of the lift assembly of FIG. 3, shown with a carrier of the lift assembly in a lowered position, according to an exemplary embodiment;

FIG. 8 is a side view of the lift assembly of FIG. 3, shown with a carrier of the lift assembly in a partially raised position, according to an exemplary embodiment;

FIG. 9 is a perspective view of a drive system for a lift assembly, according to another exemplary embodiment;

FIG. 10 is a perspective view of the drive assembly of FIG. 6, shown separated from other components of the lift assembly, according to an embodiment; and

FIG. 11 is a side cross-sectional view of the drive assembly of FIG. 9.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the Figures, a drive system (which may also be referred to as a drive assembly) for a refuse vehicle lift system (which may also be referred to as a lift assembly) is shown, according to at least one embodiment. The drive assembly is configured to power movement of a chain drive assembly to raise and lower a grabber assembly of the vehicle lift system relative to the refuse vehicle. The drive system includes a drive; and a drive mount that couples the drive in a fixed position to the lift system (e.g., to a lift arm of the lift system) such that the grabber assembly moves relative to the drive. In some embodiments, the drive system is disposed on an opposing side of the lift system as the grabber assembly. In some embodiments, the drive system also includes a gearbox that engages the drive with a pair of drive sprockets on opposing sides of the lift assembly.

Arranging the drive system in fixed position relative to the lift arm eliminates the need to move of the drive system relative to the lift arm during lifting operations (e.g., to support the weight of the drive system during a lift operation, etc.). Additionally, in various embodiments, the drive system is positioned between the lift arm and the refuse vehicle body, which can provide structural protection to the drive system on both sides of the drive system, thereby reducing the risk of damage to the drive system during operation.

### Refuse Vehicle

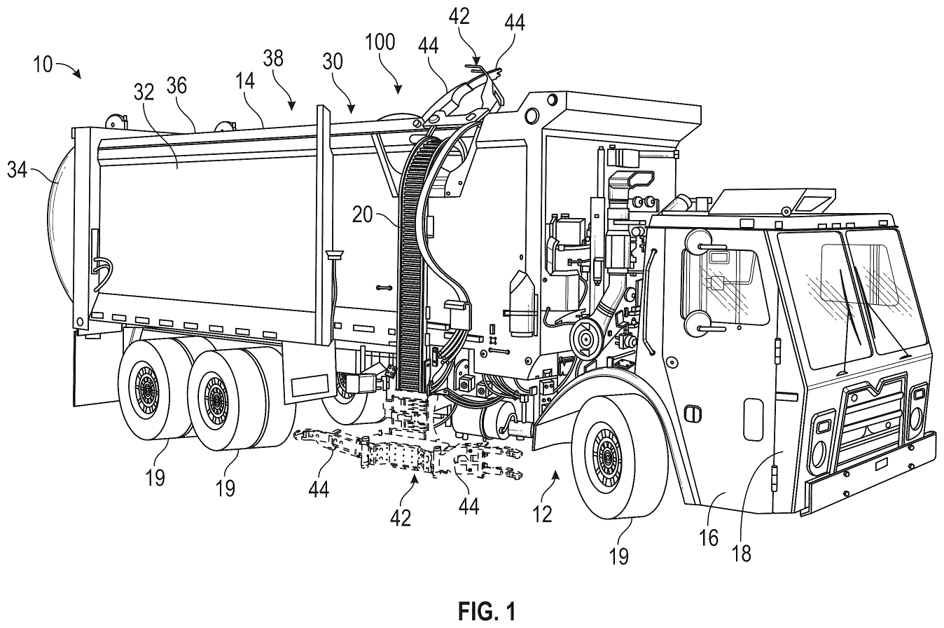

Referring to FIG. 1, a vehicle, shown as refuse vehicle 10 (e.g., a garbage truck, a waste collection truck, a sanitation truck, a refuse collection truck, a refuse collection vehicle, etc.), is configured as a side-loading refuse truck having a lift mechanism/system (e.g., a side-loading lift assembly, etc.), shown as lift assembly 100. The lift assembly 100 is coupled to a side of the refuse vehicle 10. In other embodiments, refuse vehicle 10 is configured as a front-loading refuse truck in which the lift assembly extends forward of the refuse vehicle, or a rear-loading refuse truck in which the lift assembly is disposed along a rear side of the refuse vehicle. In still other embodiments, the vehicle is another type of vehicle (e.g., a skid-loader, a telehandler, a plow truck, a boom lift, etc.).

As shown in FIG. 1, refuse vehicle 10 includes a chassis, shown as frame 12; a body assembly, shown as body 14, coupled to frame 12 (e.g., at a rear end thereof, etc.); and a cab, shown as cab 16, coupled to frame 12 (e.g., at a front end thereof, etc.). The cab 16 may include various components to facilitate operation of refuse vehicle 10 by an operator (e.g., a seat, a steering wheel, hydraulic controls, a user interface, switches, buttons, dials, etc.). As shown in FIG. 1, the refuse vehicle 10 includes a prime mover, shown as engine 18, coupled to the frame 12 at a position beneath the cab 16. The engine 18 is configured to provide power to a plurality of tractive elements, shown as wheels 19, and/or to other systems of the refuse vehicle 10 (e.g., a pneumatic system, a hydraulic system, an electric system, etc.). In some embodiments, the engine 18 is configured to utilize one or more of a variety of fuels (e.g., gasoline, diesel, bio-diesel, ethanol, natural gas, etc.). In some embodiments, the engine 18 additionally or alternatively includes one or more electric motors coupled to the frame 12 (e.g., a hybrid refuse vehicle, an electric refuse vehicle, etc.). The electric motors may consume electrical power from an on-board storage device (e.g., batteries, ultra-capacitors, etc.), from an on-board generator (e.g., an internal combustion engine, etc.), and/or from an external power source (e.g., overhead power lines, etc.) and provide power to the systems of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 together define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (i.e., refuse is loaded into a position of the refuse compartment 30 behind the cab 16 and stored in a position further toward the rear of the refuse compartment 30). In other embodiments, the storage volume is positioned between the hopper volume and the cab 16 (e.g., a rear-loading refuse vehicle, etc.).

### Lift Assembly

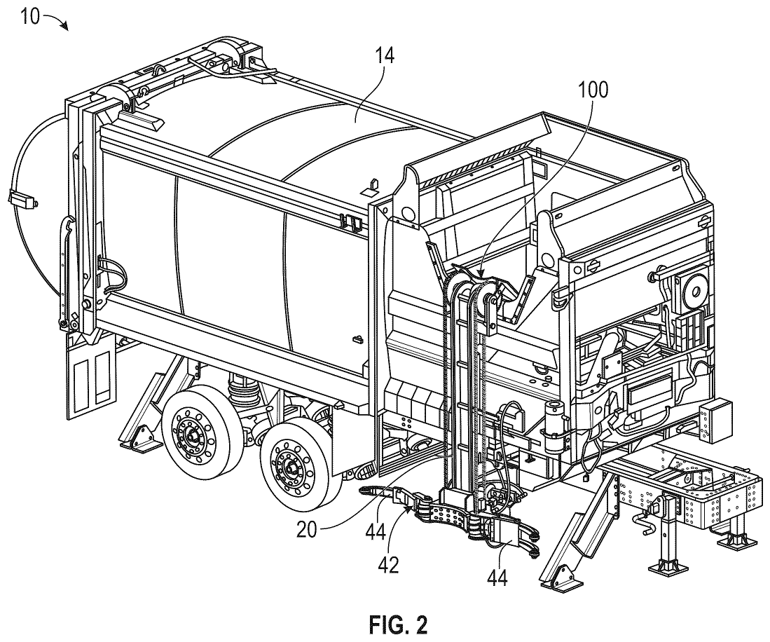

As shown in FIG. 1, the refuse vehicle 10 includes a lift mechanism/system (e.g., a front-loading lift assembly, etc.), shown as lift assembly 100. The lift assembly 100 is coupled to the frame 12 (e.g., directly to the frame 12, and/or via the body 14, etc.). Referring to FIG. 2, in some embodiments, the lift assembly 100 includes a grabber assembly (e.g., a grasping assembly, a grasping apparatus, etc.), shown as grabber assembly 42, movably coupled to a track 20, and configured to move along an entire length of the track 20. In the embodiment of FIG. 2, the track 20 extends along substantially an entire height of the body 14 and is configured to cause the grabber assembly 42 to tilt near an upper height of the body 14. In other embodiments, the track 20 extends along substantially an entire height of the body 14 on a rear side of the body 14. The refuse vehicle 10 can also include a reach system or assembly coupled with a body or frame of the refuse vehicle 10 and the lift assembly 100. The reach system can include telescoping members, a scissors stack, etc., or any other configuration that can extend or retract to provide additional reach of the grabber assembly 42 for refuse collection.

Referring still to FIG. 2, the grabber assembly 42 includes a pair of grabber arms, including a first grabber arm 44a and a second arm 44b (collectively, grabber arms 44). The grabber arms 44 are configured to rotate about an axis extending through a bushing. The grabber arms 44 are configured to releasably secure a refuse container to the grabber assembly 42, according to at least one embodiment. The grabber arms 44 rotate about the axis extending through the bushing to transition between an engaged state (e.g., a fully grasped configuration, a fully grasped state, a partially grasped configuration, a partially grasped state) and a disengaged state (e.g., a fully open state/configuration, a fully released state/configuration, a partially open state/configuration, a partially released state/configuration). In the engaged state, the grabber arms 44 are rotated towards each other such that the refuse container is grasped therebetween. In the disengaged state, the grabber arms 44 rotate outwards (as shown in FIG. 2) such that the refuse container is not grasped therebetween.

By transitioning between the engaged state and the disengaged state, the grabber assembly 42 releasably couples the refuse container with the grabber assembly 42. During a refuse collection event, the refuse vehicle 10 may pull up along-side the refuse container, such that the refuse container is positioned to be grasped by the grabber assembly 42 therebetween. The grabber assembly 42 may then transition into an engaged state to grasp the refuse container. After the refuse container has been securely grasped, the grabber assembly 42 may be transported along the track 20 with the refuse container. When the grabber assembly 42 reaches the end of the track 20 (e.g., the upper end as shown in FIG. 2), the grabber assembly 42 may tilt and empty the contents of the refuse container in the refuse compartment 30. The tilting is facilitated by the path of the track 20. When the contents of the refuse container have been emptied into the refuse compartment 30, the grabber assembly 42 may descend along the track 20, and return the refuse container to the ground. Once the refuse container has been placed on the ground, the grabber assembly may transition into the disengaged state, releasing the refuse container.

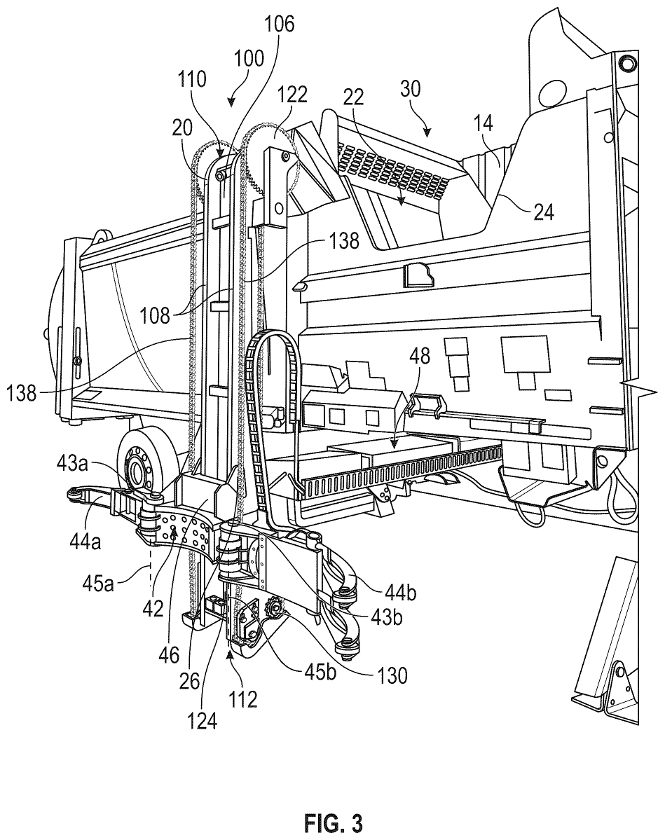

Referring to FIG. 3, the lift assembly 100 of FIG. 2 is shown in greater detail. The lift assembly 100 is configured to empty a refuse bin (e.g., a garbage can) releasably coupled to the grabber assembly 42 into the refuse compartment 30. The lift assembly 100 includes a track 20, and a coupling member, shown as carrier 26. The track 20 extends along substantially the entire height of body 14, according to the exemplary embodiment shown. The body 14 is shown to include a loading section (e.g., an opening, a hopper opening), shown as loading section 22. The loading section 22 is shown to include a recessed portion, shown as recessed portion 24.

The carrier 26 is coupled with track 20. The carrier 26 is coupled to the track 20 such that the carrier 26 may move along an entire path length of the track 20. The carrier 26 may be removably coupled to the grabber assembly 42, thereby removably coupling the grabber assembly 42 to the track 20, and allowing the grabber assembly 42 to travel along the entire path length of the track 20. The carrier 26 removably couples (e.g., by removable fasteners) to a carriage portion of the grabber assembly 42, shown as carriage 46. The grabber assembly 42 is shown to include grabber arms, shown as a first grabber arm 44a and a second grabber arm 44b, according to an exemplary embodiment. The first grabber arm 44a and the second grabber arm 44b are both configured to pivot about axis 45a and axis 45b, respectively. The axis 45a is defined as an axis longitudinally extending through substantially an entire length of a first adapter or bushing assembly, shown as a first adapter assembly 43a, and the axis 45b is defined as an axis longitudinally extending through substantially an entire length of a second adapter or bushing assembly, shown as a second adapter assembly 43b. The first adapter assembly 43a fixedly couples to a first end of carriage 46, and rotatably couples to the first grabber arm 44a. The second adapter assembly 43b fixedly couples to a second end of the carriage 46, and rotatably couples to the second grabber arm 44b. The first adapter assembly 43a and the second adapter assembly 43b couple the first grabber arm 44a and the second grabber arm 44b to the carriage 46, and allow the first grabber arm 44a and the second grabber arm 44b to rotate about the axis 45a and the axis 45b, respectively.

In some embodiments, and as shown in FIG. 3, the lift assembly 100 also includes an extension assembly 48 that is configured to move the grabber assembly 42 laterally away from the body 14. In some embodiments, the lift assembly 100, the extension assembly 38, and the grabber assembly 42 are configured to perform a grasping, lifting, and dumping operation of a refuse container by (i) extending the extension assembly 48, (ii) grasping the refuse container with the grabber assembly 42 (e.g., between the grabber arms), (iii) retracting the extension assembly 48 to the refuse vehicle 10, (iv) lifting the grabber assembly 42 along the lift assembly 100 and dumping the contents of the refuse container, (v) returning the grabber assembly 42 to the ground, (vi) extending the extension assembly 48 and the grabber assembly 42 to its original location, and (vii) releasing the refuse container from the grabber assembly 42. In some embodiments, the lift assembly 100 also includes an unhinger apparatus disposed at an upper end of the lift assembly 100 to facilitate rotation of the refuse container and emptying the contents of the refuse container into the refuse compartment of the body 14.

Referring still to FIG. 3, the lift assembly 100 includes a lift arm 106 (e.g., a mast, etc.) along which a pair of track members 108 are positioned. The track members 108 may be positioned at opposite sides of the lift arm 106 and, in some embodiments, may form part of the lift arm 106. In some embodiments, the lift arm 106 has a U-shaped profile when viewed along a lift direction. In some embodiments, the lift arm 106 defines multiple inward facing surfaces and a space for a portion of the grabber assembly 42 to translate, travel, climb, or ascend along.

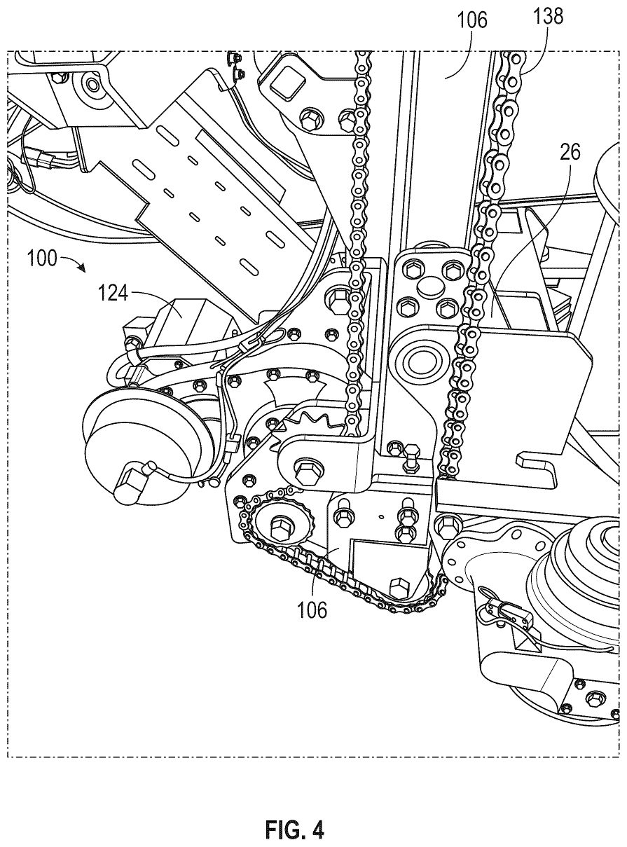

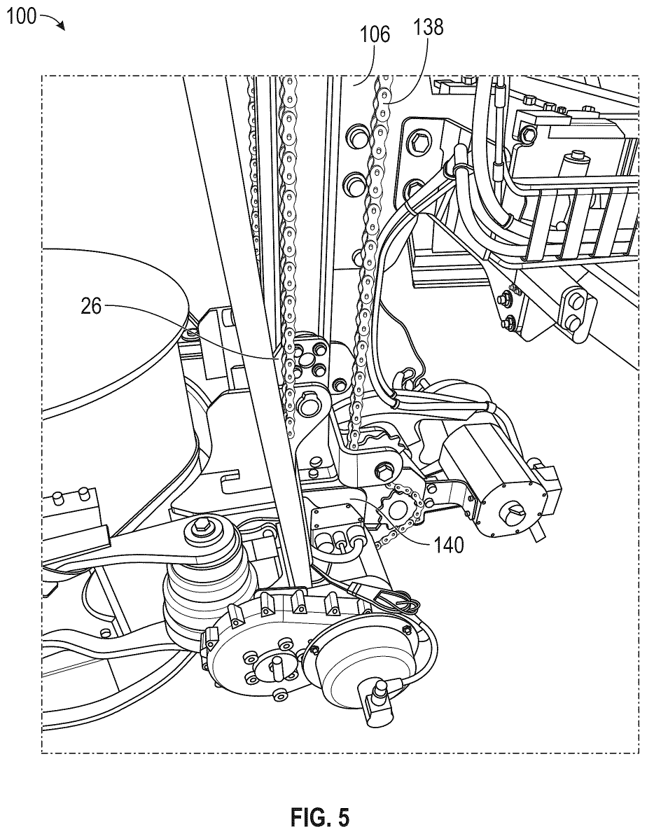

The lift assembly 100 includes a pair of drive sprockets 130 positioned at a bottom end 112 of the lift arm 106, and a pair of follower sprockets 122 or follower members (e.g., guides, pulleys, rollers, sprockets, etc.) positioned at an upper end 110 of the lift arm 106. Referring to FIG. 4-5, in some embodiments, the lift assembly 100 includes a drive motor 124 positioned at the bottom end 112 (e.g., a lower end, etc.) of the lift arm 106. The drive motor 124 is configured to operate to drive a pair of drive shafts 128 upon which the drive sprockets 130 are mounted. The lift assembly 100 also includes a pair of tensile members (e.g., chains, ropes, cables, bands, etc.), shown as chains 138 that extend between the drive sprockets 130 and the follower sprockets 122. The chains 138, drive sprockets 130, follower sprockets 122, and drive motor 124 together form at least part of a chain drive system (e.g., a chain drive assembly, etc.) that is configured to drive the grabber assembly 42 to ascend or descend the lift assembly 100.

In some embodiments, and as shown in FIG. 4-5, the lift assembly 100 (e.g., the chain drive system) also includes a lift arm tensioner assembly, shown as chain tensioner assembly 140. The chain tensioner assembly 140 is configured to maintain adequate tension on a respective one of the chains 138 throughout operation of the lift assembly 100. The chain tensioner assembly 140 also enables adjustment of a tension applied to the chain 138. In some embodiments, and as shown in FIG. 4-5, the chain tensioner assembly 140 is disposed at a lower end of the lift assembly 100. The chain tensioner assembly 140 is coupled to a lower end of the lift arm 106 and supports a lower end of the chain 138 during operation of the lift assembly 100. In other embodiments, the chain tensioner assembly 140 may be located at another position along the lift assembly 100.

### Drive Assembly

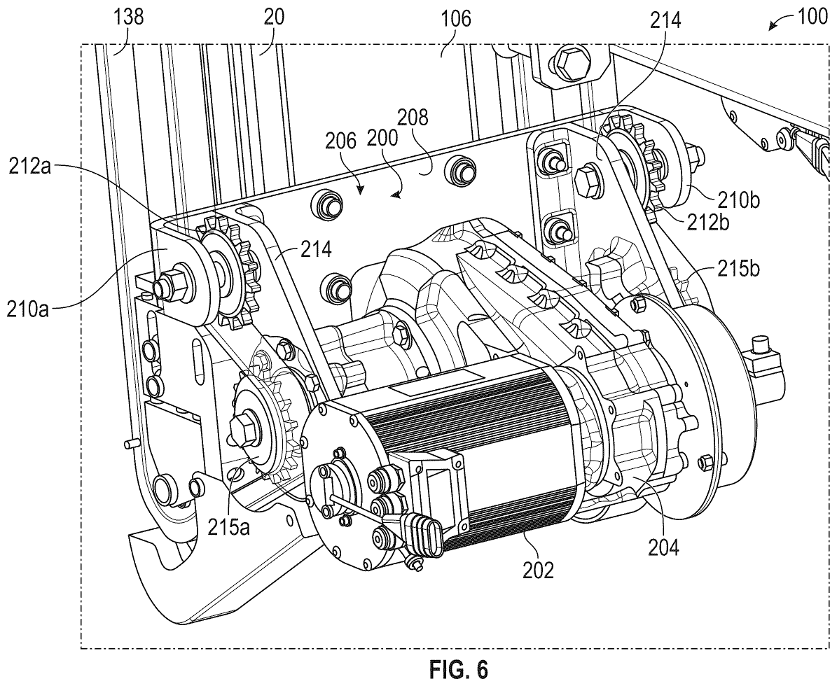

The drive system (which may also be referred to as a drive assembly and/or a chain drive assembly) includes a drive subassembly that is configured to power movement of the chains 138 and the carrier 26 (see FIG. 4-5) to ascend along the lift arm 106. Referring to FIG. 6, a drive assembly 200 is shown that may be used as or with the drive assembly of FIG. 1-5. The drive assembly 200 includes a drive motor, shown as drive 202; a gearbox 204; and a drive mount 206. In other embodiments, the drive assembly 200 may include additional, fewer, and/or different components. For example, in some embodiments, the drive assembly 200 also includes a chain (e.g., a pair of chains) and/or another tensile member to couple the drive assembly 200 to the grabber assembly.

The drive 202 is configured to power movement of (e.g., to drive) the carrier 26 (e.g., the grabber assembly 42) to move (e.g., ascend) along the track 20 (e.g., the lift arm 106). In some embodiments, and as shown in FIG. 6, the drive 202 is an electric motor. In other embodiments, the drive may include another form of drive unit to power movement of the gearbox 204. For example, the drive may include a hydraulic pump that is coupled to an engine system of the refuse vehicle via a power take-off system.

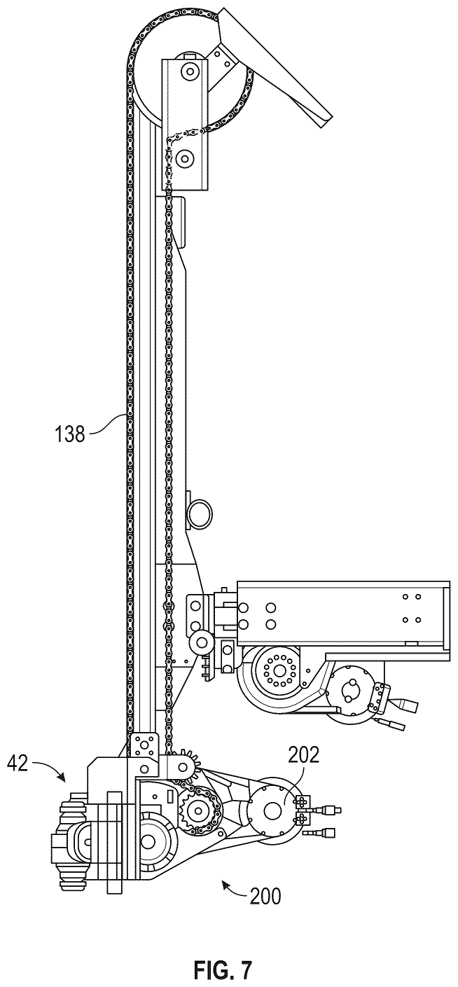

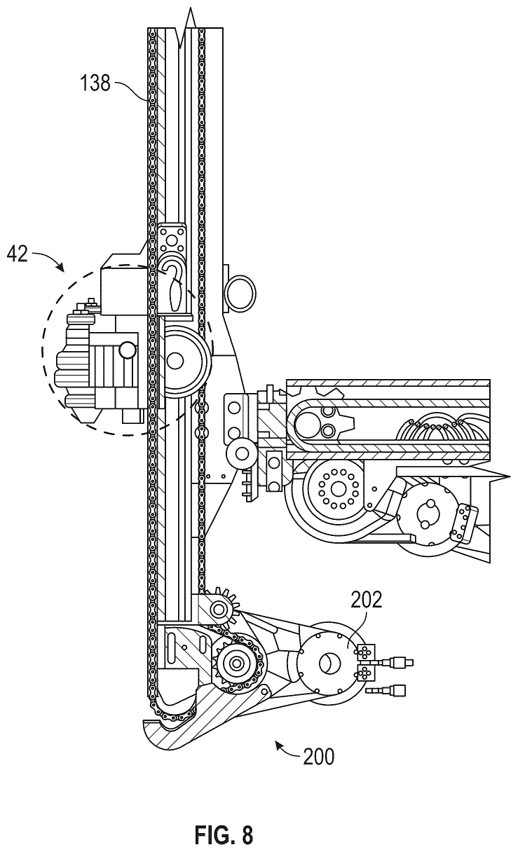

The drive mount 206 couples the drive 202 to the lift assembly 100. According to an exemplary embodiment, the drive mount 206 couples the drive 202 to the lift arm 106 and/or the track 20 at a fixed position along the track 20 such that the grabber assembly moves relative to the drive 202. Referring to FIG. 7-8, during lifting, the drive 202 powers movement of the chains 138 to raise the grabber assembly 42 independently from the drive assembly 200 (e.g., so that the drive assembly 200 remains at a fixed position along the lift arm 106). Such an arrangement eliminates the need to lift the drive with the grabber assembly 42 during operation, which can significantly reduce power requirements.

In some embodiments, and as shown in FIG. 6, the drive mount 206 is configured to support the drive 202 and the gearbox 204 on an opposite side of the lift arm 106 as the grabber assembly. In the embodiment of FIG. 6, the drive mount 206 includes a mount plate 208 (e.g., a mount panel, etc.) that is structured to engage the lift arm 106 along a rear surface of the lift arm 106 (e.g., a surface of the lift arm 106 that faces toward the refuse vehicle body). The mount plate 208 defines a plurality of fastener openings to facilitate mounting of the drive mount 206 to the lift arm 106.

In some embodiments, the drive mount 206 also includes a pair of sprocket support flanges, including a first sprocket flange 210a and a second sprocket flange 210b (collectively, sprocket support flanges 210) on an opposite side of the drive mount 206 as the first sprocket flange 210a, that are configured to rotatably couple a pair of follower sprockets, shown as a first follower sprocket 212a and a second follower sprocket 212b, of the chain drive system to the lift assembly 100. The follower sprockets 212 are configured to maintain a portion of the chain 138 proximate to a rear side of the lift arm 106 in substantially parallel orientation with respect to the lift arm 106. The follower sprockets 212 also allow the drive sprockets 215 to be spaced laterally apart from the lift arm 106 at different distances, depending on application requirements. In the embodiment of FIG. 6, the sprocket support flanges 210 extend laterally away from the mount plate 208 in a substantially perpendicular orientation with respect to the mount plate 208 (and along a lateral direction extending from the lift arm 106 toward the body).

In some embodiments, and as shown in FIG. 6, the drive mount 206 is fixedly coupled to the lift arm 106 proximate to a lower end of the lift arm 106 (e.g., below an extension arm of the lift assembly 100, etc.). Such an arrangement can reduce the risk of contact between the drive assembly 200 and the body of the refuse vehicle during operation (e.g., when retracting the grabber assembly toward the body).

The drive mount 206 supports the drive 202 and the gearbox 204 on an opposing lateral side of the lift arm 106 as the grabber assembly 42. The drive 202 is coupled laterally between the lift arm 106 and the body and/or chassis of the refuse vehicle. Such an arrangement can shield the drive 202 and the gearbox 204 from obstacles, and at least partially shield the drive and the gearbox 204 from an environment surrounding the refuse vehicle.

In other embodiments, the position of the drive mount 206, the drive 202, and the gearbox 204 along the lift assembly 100 may be different. For example, the drive assembly 200 may be coupled to the lift arm 106 proximate to an upper end of the lift arm 106 away from the chassis. Such an arrangement can reduce the length of the chains 138 under tension during operation of the lift assembly 100, which can improve overall lift performance (e.g., responsiveness, etc.). In other embodiments, the drive assembly may be positioned at another location along the lift arm 106.

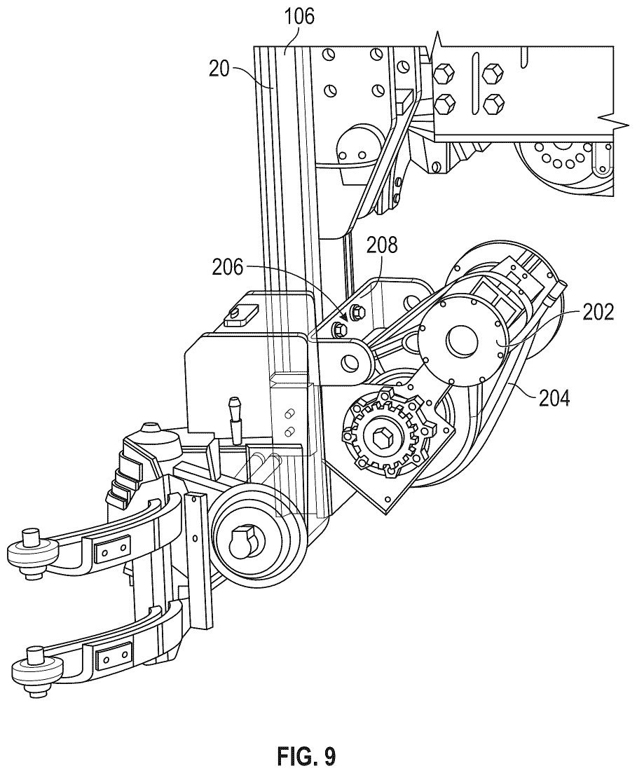

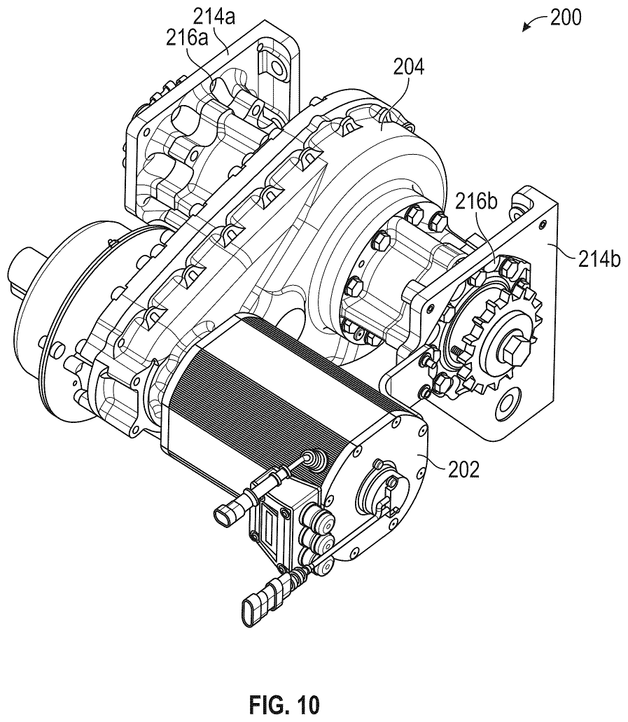

Referring to FIG. 9, in some embodiments, the drive mount 206 is structured to support the gearbox 204 and the drive 202 at different angular positions relative to the lift arm 106 (e.g., relative to the track 20, etc.). For example, and referring to FIG. 10, the drive mount 206 may also include mounting flanges, including a first mounting flange 214a and a second mounting flange 214b (collectively, mounting flanges 214) on an opposite side of the drive mount 206 as the first mounting flange 214a, that are coupled between the gearbox 204 and the mount plate 208. In some embodiments, as shown in FIG. 10, the mounting flanges 214 are formed separately from the mount plate 208 and are coupled to the mount plate 208 using bolts or another mechanical fastener. In other embodiments, the mounting flanges 214 may be welded, formed integrally with, or otherwise permanently affixed to the mount plate 208.

The mounting flanges 214 define a plurality of gearbox openings, shown as gearbox openings 216 configured to receive gearbox fasteners (e.g., bolts, etc.) to couple the gearbox 204 to the mounting flanges 214. In the embodiment of FIG. 10, the gearbox openings 216 are arranged along a circular profile, which enables securing the gearbox 204 in different angular positions relative to the mounting flanges 214 and the mount plate 208. Such an arrangement can improve utilization of the space between the drive system and the body (e.g., above or below the drive mount, depending on the application). The number and arrangement of gearbox openings 216 along the mounting flanges 214 may be different in various exemplary embodiments.

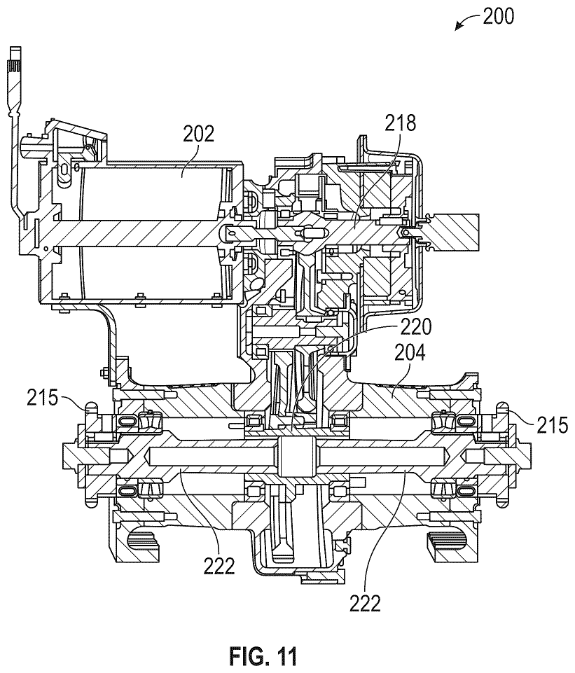

The gearbox 204 engages the drive 202 with the pair of chains of the chain drive system. The gearbox 204 is configured to distribute power from the drive 202 between the pair of chains. Referring to FIG. 11, the gearbox 204 includes an input shaft 218; an intermediate shaft 220; and a pair of output shafts, shown as output shafts 222. The drive 202 is coupled to the input shaft 218 and powers movement of the input shaft 218 during operation. The intermediate shaft 220 is coupled between the input shaft 218 and the output shafts 222, and couples the input shaft 218 to both of the output shafts 222 so that power from the input shaft 218 is transmitted to the output shafts 222 simultaneously. In some embodiments, the intermediate shaft 220 is a bushing that receives the output shafts 222 therein and supports the output shafts 222 in coaxial alignment with one another.

Each of the drive sprockets 215 is coupled to a respective one of the output shafts 222. In the embodiment of FIG. 11, the mounting flanges 214 are disposed between the drive sprockets 215 and the output shafts 222.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. Such members may be coupled mechanically, electrically, and/or fluidly.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” etc.) are merely used to describe the orientation of various elements in the Figures. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire suppression system as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

What is claimed is:

1. A refuse vehicle comprising:
a chassis; and
a lift assembly coupled to the chassis, the lift assembly comprising:
a lift arm;
a grabber assembly movably coupled to the lift arm;
a drive configured to drive the grabber assembly to move along the lift arm; and
a drive mount coupling the drive to the lift arm at a fixed position along the lift arm such that the grabber assembly moves relative to the drive.

2. The refuse vehicle of claim 1, further comprising:
a pair of chains supported along the lift arm; and
a gearbox engaging the drive with the pair of chains.

3. The refuse vehicle of claim 2, wherein the drive mount is structured to support the gearbox at different angular positions with respect to the lift arm.

4. The refuse vehicle of claim 2, wherein the gearbox comprises:
a pair of output shafts, each output shaft of the pair of output shafts configured to power movement of a respective one of the pair of chains; and
an intermediate shaft coupled to the pair of output shafts, wherein the drive is configured to power movement of the intermediate shaft.

5. The refuse vehicle of claim 1, further comprising a track including a pair of track members that are coupled to the lift arm, and wherein the grabber assembly and the drive are disposed on opposite sides of the lift arm.

6. The refuse vehicle of claim 1, wherein the drive is coupled laterally between the lift arm and the chassis.

7. The refuse vehicle of claim 1, further comprising an extension arm configured to extend the lift arm away from the chassis, wherein the drive mount is coupled to the lift arm proximate to a lower end of the lift arm and below the extension arm.

8. The refuse vehicle of claim 1, wherein the drive mount is coupled to the lift arm proximate to an upper end of the lift arm away from the chassis.

9. The refuse vehicle of claim 1, further comprising a gearbox to the drive, wherein the drive mount comprises mounting flanges on opposing sides of the drive mount that are coupled between the gearbox and the lift arm, the mounting flanges defining a plurality of gearbox openings arranged along a circular profile.

10. A lift system for a refuse vehicle, the lift system comprising:
a lift assembly comprising:
a lift arm configured to be coupled to the refuse vehicle; and
a grabber assembly movably coupled to the lift arm; and
a drive assembly coupled to the lift assembly, the drive assembly comprising:
a drive;
a tensile member coupled to the grabber assembly and extending substantially parallel to the lift arm;
a gearbox engaging the drive with the tensile member; and
a drive mount coupling at least one of the drive or the gearbox to the lift arm at a fixed position along the lift arm such that the grabber assembly moves relative to the at least one of the drive or the gearbox during operation.

11. The lift system of claim 10, wherein the tensile member comprises a pair of chains supported along the lift arm, the gearbox engaging the drive with the pair of chains.

12. The refuse vehicle of claim 10, wherein the drive mount is structured to support the at least one of the drive or the gearbox at different angular positions with respect to the lift arm.

13. The lift system of claim 10, further comprising a track including a pair of track members that are coupled to the lift arm, and wherein the grabber assembly and the drive are disposed on opposite sides of the lift arm.

14. The lift system of claim 10, wherein the gearbox comprises:
a pair of output shafts, each output shaft of the pair of output shafts configured to power movement of a respective one of the pair of chains; and
an intermediate shaft coupled to the pair of output shafts, wherein the drive is configured to power movement of the intermediate shaft.

15. The lift system of claim 10, further comprising an extension arm configured to couple the lift arm to the refuse vehicle, wherein the drive mount is coupled to the lift arm proximate to a lower end of the lift arm and below the extension arm.

16. The lift system of claim 10, further comprising an extension arm configured to couple the lift arm to the refuse vehicle wherein the drive mount is coupled to the lift arm proximate to an upper end of the lift arm and above the extension arm.

17. The lift system of claim 10, wherein the drive mount comprises mounting flanges on opposing sides of the drive mount that are coupled between the gearbox and the lift arm, the mounting flanges defining a plurality of gearbox openings arranged along a circular profile.

18. A drive system for a lift assembly, the drive system comprising:
a drive;
a tensile member configured to couple to a grabber assembly of the lift assembly;
a gearbox engaging the drive with the tensile member; and
a drive mount configured to couple at least one of the drive or the gearbox to a lift arm of the lift assembly at a fixed position along the lift arm such that the grabber assembly moves relative to the at least one of the drive or the gearbox during operation.

19. The drive system of claim 18, further comprising a pair of drive sprockets coupled to the gearbox on opposite sides thereof, wherein the drive mount comprises:
a mount plate that is structured to engage the lift arm, the mount plate defining a plurality of fastener openings to mount the drive mount to the lift arm; and
a pair of sprocket support flanges extending from the mount plate and coupled to the pair of drive sprockets.

20. The drive system of claim 18, wherein the drive mount comprises mounting flanges on opposing sides of the drive mount that are coupled between the gearbox and the lift arm, the mounting flanges defining a plurality of gearbox openings arranged along a circular profile.
